(19) United States
(12) Patent Application Publication
(10) Pub. No.: US 2002/0010709 A1
(43) Pub. Date: Jan. 24, 2002

(54) Method and system for distilling content

(76) Inventors: Daniel Jason Culbert, Sunnyvale, CA (US); Denis Gulsen, Redwood City, CA (US)

Correspondence Address: Daniel Culbert, 1035 Aster Ave # 2196, Sunnyvale, CA, 94086, US

(21) Appl. No.: 09/792,522

(22) Filed: Feb. 26, 2001

Related U.S. Application Data
(60) Provisional application No. 60/184,068, filed on Feb. 22, 2000.

(51) Int. Cl. G06F 17/00

(52) U.S. Cl. 707/500; 709/1

(57) ABSTRACT

This is a system and method for processing and selectively storing content of an Internet web site. A key aspect of each variation of the invention is the distillation of information associated with an Internet location to which the user has browsed using various algorithms operating in the background to produce a linked group of distilled pieces of information (a “datagram”) which may be used in various ways for or by the user.

### TECHNICAL FIELD

This invention relates generally to integrated systems and networks for processing information and more particularly to systems and methods for processing information available at various locations of disparate networks to form data groupings containing selected content.

### BACKGROUND ART

Several new techniques and systems for processing and retrieving information have been developed with the proliferation of the Internet. Some of these developments are described in published documents.

In U.S. Pat. No. 5,937,407, an information retrieving apparatus is disclosed. The apparatus comprises a retrieve instruction executing means for executing a retrieve instruction based on a retrieval formula described based on an arbitrary schema, a schema conversion means for converting the retrieval formula into another retrieval formula according to another schema based on pregiven rules, and a schema management means for managing the rules for converting the retrieval formula into the other retrieval formula, wherein the retrieve instruction executing means retrieves desired information based on the other retrieval formula.

In U.S. Pat. No. 5,161,225, a persistent stream for processing time consuming and reusable queries in an object oriented database management system is disclosed. Time consuming and reusable queries are handled in an object oriented database management system by providing a persistent stream object class. The persistent stream object class is a subclass of the stream class which is typically provided to encapsulate the results of a query. The persistent stream class inherits all the attributes and methods of the stream class but also includes a “save” method for saving the results of a query. When a query names a persistent stream as it object, the query results are saved. The query may also be performed in background or batch mode. All time consuming and reusable queries are performed by sending a query message to the persistent stream class, to thereby automatically save the query results.

In U.S. Pat. No. 5,278,980, an iterative technique for phrase query formation and an information retrieval system employing the interactive technique are disclosed. An information retrieval system and method are provided in which an operator inputs one or more query words which are used to determine a search key for searching through a corpus of documents, and which returns any matches between the search key and the corpus of documents as a phrase containing the word data matching the query word(s), a non-stop (content) word next adjacent to the matching word data, and all intervening stop-words between the matching word data and the next adjacent non-stop word. The operator, after reviewing one or more of the returned phrases can then use one or more of the next adjacent non-stop-words as new query words to reformulate the search key and perform a subsequent search through the document corpus. This process can be conducted iteratively, until the appropriate documents of interest are located. The additional non-stop-words from each phrase are preferably aligned with each other (e.g., by columnation) to ease viewing of the “new” content words.

In U.S. Pat. No. 5,745,754, a sub-agent for fulfilling requests of a web browser using an intelligent agent and providing a report is disclosed. A World Wide Web browser makes requests to web servers on a network which receive and fulfill requests as an agent of the browser client, organizing distributed sub-agents as distributed integration solution (DIS) servers on an intranet network supporting the web server which also has an access agent servers accessible over the Internet. DIS servers execute selected capsule objects which perform programmable functions upon a received command from a web server control program agent for retrieving, from a database gateway coupled to a plurality of database resources upon a single request made from a Hypertext document, requested information from multiple data bases located at different types of databases geographically dispersed, performing calculations, formatting, and other services prior to reporting to the web browser or to other locations, in a selected format, as in a display, fax, printer, and to customer installations or to TV video subscribers, with account tracking.

In U.S. Pat. No. 5,877,759, and interface for user/agent interaction is disclosed. A user interface, for example for Internet and intranet agents, embodies the technical potential of automation and delegation into a cohesive structure. The invention also provides intelligent assistance to the client user interface and provides an interface that is centered on autonomous processing of whole tasks rather than sequences of commands, as well as the autonomous detection of contexts which require the launch of a process, especially where such context is time-based.

U.S. Pat. No. 5,761,496 describes a similar information retrieval system and method. The retrieval request input means 110 reads a retrieval request consisting of input keywords set up by the user as well as their importance degrees. The retrieval management section 120 causes the relation keyword generation section 121 and the retrieval expression generation section 122 to generate a retrieval expression by using background knowledge and retrieval parameters. The retrieval management section 120 causes the database management section to retrieve data from the database 160 based on a generated retrieval expression, causes the relation data acquisition section 124 to present a temporary retrieval result to the user, and causes the relevance database management section 123 to store user-instructed relation data into the relevance database 150. The retrieval management section 120 changes the retrieval parameters based on this relation data, causes the retrieval expression generation section 122 to generate a mew retrieval expression, and causes the database management section 125 to retrieve data again. The retrieval result output section 130 outputs the final retrieval result. Thus, this system allows the user to reflect his retrieval strategy and background knowledge about data easily and precisely and to execute similarity retrieval efficiently on a trial and error basis, without a substantial increase in the retrieval time.

In U.S. Pat. No. 5,768,578, a user interface for an information retrieval system is described. An improved information retrieval system user interface for retrieving information from a plurality of sources and for storing information source descriptions in a knowledge base. The user interface includes a hypertext browser and a knowledge base browser/editor. The hypertext browser allows a user to browse an unstructured information space through the use of interactive hypertext links. The knowledge base browser/editor displays a directed graph representing a generalization taxonomy of the knowledge base, with the nodes representing concepts and edges representing relationships between concepts. The system allows users to store information source descriptions in the knowledge base via graphical pointing means. By dragging an iconic representation of an information source from the hypertext browser to a node in the directed graph, the system will store an information source description object in the knowledge base. The knowledge base browser/editor is also used to browse the information source descriptions previously stored in the knowledge base. The result of such browsing is an interactive list of information source descriptions which may be used to retrieve documents into the hypertext browser. The system also allows for querying a structured information source and using query results to focus the hypertext browser on the most relevant unstructured data sources.

In U.S. Pat. No. 5,918,214, a system and method for finding product and service related information on the Internet are described. A novel system and method for finding product and service related information on the Internet. The system includes Internet Servers which store information pertaining to Universal Product or Service Number (e.g. UPC number) preassigned to each product and service registered in the system, with Uniform Resource Locators (URLs) that point to the location of one or more information resources on the Internet, e.g. World Wide Websites, related to such products or services. Each client computer system includes an Internet browser or Internet application tool which is provided with a “Internet Product/Service Information (IPSI) Finder” button and a “Universal Product/Service Number (UPSN) Search” button. The system enters its “IPSI Finder Mode” when the “IPSI Finder” button is depressed and enters the “UPSN Search Mode” when the “UPSN Search” button is depressed. When the system is in its IPSI Finder Mode, a predesignated information resource (e.g. advertisement, product information, etc.) pertaining to any commercial product or service registered with the system is automatically accessed from the Internet and displayed from the Internet browser by simply entering the registered product's UPN or the registered service's USN into the Internet browser. When the system is in its “UPSN Search Mode”, a predesignated information resource pertaining to any commercial product or service registered with the system is automatically accessed from the Internet and displayed from the Internet browser by simply entering the registered product's trademark(s) or (servicemark) and/or associated company name into the Internet browser.

In U.S. Pat. No. 5,761,663, a method for distributed task fulfillment of web browser requests is described. A World Wide Web browser makes requests to web servers on a network which receive and fulfill requests as an agent of the browser client, organizing distributed sub-agents as distributed integration solution (DIS) servers on an intranet network supporting the web server which also has an access agent servers accessible over the Internet. DIS servers execute selected capsule objects which perform programmable functions upon a received command from a web server control program agent for retrieving, from a database gateway coupled to a plurality of database resources upon a single request made from a Hypertext document, requested information from multiple data bases located at different types of databases geograhically dispersed, performing calculations, formatting, and other services prior to reporting to the web browser or to other locations, in a selected format, as in a display, fax, printer, and to customer installations or to TV video subscribers, with account tracking.

U.S. Pat. No. 5,913,215 discloses an apparatus and method for identifying one of a plurality of documents stored in a computer-readable medium. The method includes the steps of prompting a computer-user to construct a search expression, then communicating the search expression to each of a plurality of search engines located at respective World Wide Web sites. Each of the plurality of search engines is prompted to concurrently identify a respective plurality of web pages containing text consistent with the search expression and to return a respective URL for each such web page identified. Redundant URLs returned by the search engines are filtered to obtain an initial set of web pages. Each of the initial set of web pages is downloaded and linguistically analyzed to automatically identify for the computer-user keyword phrases therein. The computer-user is prompted to construct a query expression in which one or more keyword phrases from the initial set of web pages is an operand. The query expression is then used to identify at least one web page of the initial set of web pages and the identified web page is presented to the user in the form of an abstract.

In U.S. Pat. No. 5,907,838, an information search and collection method and system are described. A method and apparatus in which category classes express information content categories that are defined based on object-oriented programming. The information items that are to be collected for each category are set as properties, and an information acquisition method or information process and treatment method is described for each property. After a request input from a user has been converted into a request input format that the system can understand, the request input is classified into category classes, searching is performed, and the information items the system outputs are displayed using the properties of the classes to which the request input belongs. Information searching and collection is accomplished on the basis of the contents described by the methods, and the information is output as comprehensive information in accordance with the request input of the user.

In U.S. Pat. No. 5,793,964, a web browser system is described. A World Wide Web browser makes requests to web servers on a network which receive and fulfill requests as an agent of the browser client, organizing distributed sub-agents as distributed integration solution (DIS) servers on an intranet network supporting the web server which also has an access agent servers accessible over the Internet. DIS servers execute selected capsule objects which perform programmable functions upon a received command from a web server control program agent for retrieving, from a database gateway coupled to a plurality of database resources upon a single request made from a Hypertext document, requested information from multiple data bases located at different types of databases geograhically dispersed, performing calculations, formatting, and other services prior to reporting to the web browser or to other locations, in a selected format, as in a display, fax, printer, and to customer installations or to TV video subscribers, with account tracking.

U.S. Pat. No. 5,913,214 describes a system for querying disparate, heterogeneous data sources over a network, where at least some of the data sources are World Wide Web pages or other semi-structured data sources, includes a query converter, a command transmitter, and a data retriever. The query converter produces, from at least a portion of a query, a set of commands which can be used to interact with a semi-structured data source. The query converter may accept a request in the same form as normally used to access a relational data base, therefore increasing the number of data bases available to a user in a transparent manner. The command transmitter issues the produced commands to the semi-structured data source. The data retriever then retrieves the desired data from the data source. In this manner, structured queries may be used to access both traditional, relational data bases as well as non-traditional, semi-structured data bases such as web sites and flat files. The system may also include a request translator and a data translator for providing data context interchange. The request translator translates a request for data having a first data context into a query having a second data context which the query converter described above. The data translator translates data retrieved from the data context of the data source into the data context associated with the request. A related method for querying disparate data sources over a network is also described.

In U.S. Pat. No. 5,931,907, a software agent for comparing locally accessible keywords with meta-information and having pointers associated with distributed information is disclosed. A system for accessing information stored in a distributed information database provides a community of intelligent software agents. Each agent can be built as an extension of a known viewer for a distributed information system such as the Internet World Wide Web. The agent is effectively integrated with the viewer and can extract pages by means of the viewer for storage in an intelligent page store. The text from the information system is abstracted and is stored with additional information, optionally selected by the user. The agent-based access system uses keyword sets to locate information of interest to a user, together with user profiles such that pages being stored by one user can be notified to another whose profile indicates potential interest. The keyword sets can be extended by use of a thesaurus.

At present, it is very common for users of the Internet to manually search for relevant information using search engines such as those available at Internet locations such as Yahoo! (www.yahoo.com) or AltaVista (www.altavista.com). Other Internet services, such as those available at Ask Jeeves (www.ask.com) or MetaCrawler (www.metacrawler.com), are configured to use a single query to search more than one other service for relevant information based upon the user's manually entered query. While each of these services may be useful, each requires the manual entry of information. With manual entry techniques, users spend time experimenting with entry keywords and looking through long lists of available content which may or may not be relevant or useful.

Some other providers, such as FlySwat (www.flyswat.com), have attempted to bypass this manual information entry step by analyzing all or most of the text content of a page which a user is visiting. While such techniques may bypass the manual entry step, they may also return to the user content which is not particularly relevant or desirable because they generally have no means for distilling the content of a visited page into associated pieces of information which may be used to search for and return to the user content which is more likely to be useful and relevant.

There is a need for a system and method for efficiently distilling the content of visited pages into meaningful subgroups of information. Distilled content may be used for various purposes such as reduced content browsing and focussed background searching.

### SUMMARY OF THE INVENTION

This is a method for distilling content from an Internet location. In one variation, the inventive method comprises comparing URL information associated with an Internet location with a rule trigger in a manner which compares characters comprising the URL with rule trigger characters which comprise the rule trigger to find a match. A rule, or rule algorithm, is then executed based upon the associated match to extract subexpressions from HTML and URL information of the Internet location and compile the subexpressions into a distilled data packet, or datagram.

In another variation, the inventive method comprises comparing the characters of URL information associated with an Internet location with the characters of each of a set of rule triggers to calculate scores for the comparisons based upon numbers of matches and weights assigned to each. The highest scoring rule having a score greater than some threshold score is applied as the default rule.

In another variation, the inventive method comprises comparing the characters of URL information associated with an Internet location with the characters of each of a set of rule triggers to calculate scores for the comparisons based upon numbers of matches and weights assigned to each. A rule algorithm associated with the rule trigger with the greatest score which is greater than or equal to a threshold score is executed to extract subexpressions from the HTML and URL information associated with the Internet location and compile the subexpressions into a datagram.

In another variation, the inventive method comprises downloading a first content-known page having first content comprising a first value for a keyword or tag. A first minimum regular expression is formed to extract the first value for the first keyword. A second content-known page is then downloaded. The second content-known page comprises a second value for the keyword. A second minimum regular expression is then formed to extract the second value for the keyword. The first and second minimum regular expressions are compared and a determination is made regarding which one better extracts values for the keyword.

### DETAILED DESCRIPTION

A key aspect of each variation of this invention is the distillation of information associated with an Internet location to which the user has browsed using various algorithms operating in the background to produce a linked grouping of distilled pieces of information (hereinafter a “datagram”) which may be used in various ways to help the user. The invention comprises techniques for leveraging the inventive datagram creation process in other information processing and transmission processes such as reduced display browsing, datamining, and selected content provision.

The Internet is a collection of information storage devices and processors disparately located and connected electronically to each other by network conduits comprising physical elements, such as fiber optic cables, or wireless technology which enables devices to communicate without physical contact. Users of the Internet typically find information using browser software, such as Microsoft Internet Explorer or Netscape Navigator, which is configured to navigate a text-based version of the Internet called the World Wide Web (hereinafter “the web”) by reading and downloading information such as text, which is generally made available by programmers in HTML (hypertext markup language) format.

Browser software typically is installed on a user's local information system, such as a personal computer, personal data assistant (“PDA”), cell phone, or similar device which generally has temporary memory, such as random access memory (or “RAM”), more permanent storage capacity, such as that provided by a hard disk drive, a locally installed information processing device such as a Pentium(TM) microprocessor, and an Internet connectivity device such as a modem. The Internet connectivity device generally is configured to establish electronic contact between a local information system and a remotely located device, such as a modem bank of an Internet service provider, which bridges the electronic connection of the local information system to other systems connected via the Internet. In the case of some devices such as digital cell phones, an Internet connectivity device may not be required, as the digital cell phone may contact the Internet directly or indirectly without the use of a modem, depending upon the cell phone network configuration.

When a user browses the web from a local information system, information from remote systems is transferred (or “downloaded”) from the remote systems to his local system, often in HTML format. The user's locally installed browser software is configured to display a web “page” based upon the content of the downloaded information, which may comprise text, pictures, movie clips, music clips, and other elements known in the art of web design.

A key aspect of browsing the web is telling the browser software where to seek information which may subsequently be downloaded to the user's local information system. Browser software, such as Microsoft Internet Explorer and Netscape Navigator, is generally configured to provide the user with several options for navigating. Depending upon the content programmed into the particular web page, the user may be provided with “links” which are configured to download content associated with such links to the user's computer. Each link is associated with a Uniform Resource Locator, or URL, which is a brief instruction set pointing to the desired information. Links are generally displayed on a web page using a standard bold/underlined format in a particular color, such as blue, designed to communicate to the user that he will receive content associated with the link by “clicking” on the link using his pointing device (such as a mouse or other pointing device known to those skilled in the art of personal information system design).

Most browser software also allows users to directly input URL text for download of the associated information without the step of clicking on a link.

When a user uses a typical “search engine”, such as that found at www.altavista.com, to find desired content, he generally enters text keywords, activates a search, and receives a list of links in return, the links being associated with URLs.

In short, browsing the web comprises using a URL to download information, generally comprising text, from a remote information system to a local information system.

Datagrams:

This invention comprises a method and apparatus for analyzing the content of URLs and HTML pages to form distilled data packets or “datagrams” comprising portions of the URL or HTML content selected according to a set of rules. A datagram is a description of the content of a web page. It may contain a complete description of all of the contents of the web page, but typically contains only the most essential pieces of information to describe the primary context of the web page. Datagrams generally are formatted in XML, a format which allows the data contained within to be highly structured and unambiguous. Datagrams generated by the inventive system may be stored, in database format, for example, remotely or locally and used for various purposes, such as searching for content on the web based upon datagram content, or enabling certain forms of reduced display browsing. In one variation, a datagram comprises a grouping of tag/value pairs. In another variation, a datagram may comprise portions of a URL.

Datagram Formation:

To form a datagram, URL or HTML information must somehow be captured and analyzed. In one variation, this is accomplished using a piece of software known to those skilled in the art of computer software development as a “plug-in”. The plug-in is configured to add new functionality to the existing browser software. In this variation, a plug-in is configured to “handshake” with the browser software in a manner wherein it receives URL and HTML information from the browser software and may cause the browser to send out URLs to download certain information. The plug-in also is configured to process incoming URL and HTML information using software rules which may be resident within the plug-in or located remotely on another information system such as a server. In another variation, datagram formation may occur entirely on a remote information system such as a server. Entirely server-based variations may be preferred for certain applications of the inventive datagram formation techniques, such as datamining and reduced display browsing.

Having a plug-in or other infrastructure for receiving, comparing, and sending URL and HTML information is only a portion of the preferred datagram formation process. In order to extract or distill content from a web page into a datagram, the invention must have some technique for determining what in particular to extract from the available information.

Rules:

In the preferred variation, “rules” dictate what content will comprise the datagram for a particular page. Since many web pages are different in that they have different information at different locations on their pages, different rules are needed for different pages.

For example, if the user is looking for a video and browses to an Amazon.com web page using the URL “http://www.amazon.com/exec/obidos/6302935148/ref=ed_oe_v hs/103-5023833-6266201”, his local browser will download a web page comprising a video title, a purchase price, an image, and the star of the video movie. In this example, the title is the first item in the upper left corner of the page. An image of the video cover is below the title. The price is next to the “$” symbol, and the star, Tom Cruise, is next to the term “Starring:”.

Finding the same item at Blockbuster (using, for example, the URL “http://www.blockbuster.com/mv/detail.jhtml?prodid=97402& catid=500”) results in a similar but different page with the image in the upper left corner, the title to the right of the image, the stars next to “Actors:”, and the price next to the “$” symbol.

If it is desirable to distill the content of the two pages associated with the two aforementioned URLs, say perhaps into movie title, lead actor, price, and vendor, for comparison purposes, for example, then two different rules will be needed: one rule configured specifically to extract this information from the Amazon.com page, and the other configured specifically to do the same from the Blockbuster page. To select which rule or rules should be executed for a given web page, the preferred variation utilizes “rule trigger logic”.

In the preferred variation, the URL of a web site which the user is viewing is sent to the plug-in and is analyzed by this preprogrammed rule trigger logic. The rule trigger logic, preferably coded as part of the software running locally due to speed advantages, is configured to examine the content of the text which comprises the URL, and to execute specific rules logically related to specific triggers in the trigger logic. For example, if the user is at the URL “http://www.amazon.com/exec/obidos/6302935148/ref=ed_oe_v hs/103-5023833-6266201”, the preferred variation of the plug-in software would receive this URL as text after a “document complete” signal from the browser software and would analyze the whole phrase as well as subportions thereof. The rule trigger logic, preferably character string comparison logic, a set of “if-then” statements or a “hash table lookup” for comparing character string portions, or similar coding technique known to computer programmers, would be executed to analyze the URL. The object of the rule trigger logic is the find executable rules which are applicable to the particular site and execute these rules. Using the aforementioned pages to demonstrate, the rule trigger logic will be configured to analyze “http://www.amazon.com/exec/obidos/6302935148/ref=ed_oe_v hs/103-5023833-6266201” and make note of phrases such as “amazon.com” and “vhs” so a rule specifically designed to extract the proper distilled information from an Amazon.com videotape product page could be selected and executed. In other words, the phrases “amazon.com” and “vhs” within the same URL may “trigger” a specific rule.

The subprocess of triggering rules may be simple or complex, depending upon the complexity of the rule trigger patterns being analyzed. For example, a trigger pattern may operate somewhat like “if A, then execute rule #1”. This requires only very simple analysis to determine if “A” exists within the content of the page. If it is there, “rule #1” is executed. On the other hand, a trigger pattern may operate somewhat like “If A, and B, and C, and D, and E, then execute rule #2”. In this case, “rule #2“has more specific requirements and may not be executed as often as “rule #1” because each of “A” through “E”, inclusive, must be present. If the rule trigger logic is analyzing 100 similarly detailed rule trigger patterns simultaneously to determine which rules to execute given the content of a page, a significant amount of processing may be required. The creation of rule trigger patterns may occur manually using experimentation, or may occur automatically, as is described below.

The rules, preferably “regular expressions” or XML objects, each of which are known to programmers and described at online sites such as www.w3.org or in publications such as Learning Perl (O'Reilly & Associates, Inc., 1993), may generally be described as comprising pattern matching objects configured to extract phrases known as subexpressions from both the URL and HTML content associated with the downloaded page. Rules may be implemented in any form of computer instruction (binary, interpreted, or data-driven, for example). A rule might extract subexpressions from not only the page content, such as the movie title and product price, but also from the URL itself, such as the phrase “amazon.com”. It is the extracted subexpressions which become portions of the datagram.

In the preferred variation, a datagram comprises at least one set of “tag/value pairs”. The goal of the rules is to provide values to match with the tags in a completed datagram. For example, a datagram shell for a rule configured to distill the content of an Amazon.com videotape product page may comprise four tags: title, star, price, and vendor. When the proper rule executes, preferably locally using the plug-in as a conduit for the URL and HTML information, it will return subexpression values to match the three tags and the result will, hypothetically, be the following tag/value pairs: title/“The Firm”, star/“Tom Cruise”, price/“19.95”, vendor/“amazon.com”. Another rule configured to extract similar subexpressions from Blockbuster pages could return a datagram with the following tag/value pairs: title/“The Firm”, star/“Tom Cruise”, price/“19.95”, vendor/“blockbuster.com”. One can see that a price comparison between the two vendors could be accomplished quite easily having these two datagrams; indeed, price comparison is one of the many objects of this invention.

Default Rules:

In accord with the discussion above, after the rule trigger logic is used to determine which rule should be executed, the proper subexpressions may be extracted from the content comprising the web page. In situations where no specific rule match is found after the rule trigger logic is applied, a default rule may be selected or developed to extract selected subexpressions despite the failure to find a specific rule match. Several varations of default rule based datagram formation, or “default distillation”, have been developed.

In one variation of default distillation, each available rule may be executed upon the content associated with the web page (URL information, HTML text content, etc.). The results of the each rule execution are scored, based upon the number of rule trigger matches and a weight assigned to each match which is related to the descriptiveness of the particular match (ISBN number, for example, an international number associated with a specific book, would be highly weighted). The rule having the highest score above some threshold number would be assigned to the particular page as the default rule and the results of the rule execution would become the distilled data for the page.

In another variation, each of the rules may be executed, and a hybrid datagram returned containing the value content associated with each matching key/value pair having a weight over a threshold amount.

In another variation of default distillation, the content associated with the web page (URL information, HTML text content, etc.) is searched for “known” values, which are associated with tags. A database of known tags/value pairs and groupings thereof is stored either on the local information system or on a remote system. Within each grouping, each of the known tag/value pairs is assigned a weight, depending upon it's usefulness in identifying something from the page. For example, if a user is looking for a book at Amazon.com, the ISBN tag, associated with the book's ISBN number, would be assigned a relatively high weight. A score for a grouping of tag/value pairs would be calculated as the number of tag/value pair matches with a particular page, influenced by the weight of each match. The highest scoring grouping, above some threshold score, would be selected and the matches within this grouping would comprise the datagram. If, for example, the user came upon a page and the rule trigger logic was not able to identify and execute a specific rule particularly tailored for the page, but the default rule process was able to identify an ISBN value and a $ value, the textual content adjacent the “$” and “ISBN” tags, or the values, could be extracted. Having these two tag/value pairs at the same page is somewhat indicative that the user is at a book page and the price is given on the page. The ISBN number and the price information may be stored as distilled content of the page. If a significant list of groupings with similarly high scores results, the tag/value pairs of the groupings are analyzed to develop categorical information which may be returned as the datagram content. For example, if a large list of high scoring groupings is returned from the analysis, each of which has an ISBN number as a tag/value pair, it may be decided that the user is examining a book page, and book-related categorical content may be returned as the datagram content.

In another variation known as “reverse lookup”, the URL for the particular page is sampled and analyzed by comparing the text comprising it with elements of a directory database which may be locally or remotely resident. The directory database is comprised of keywords from the titles of various hierarchy branches within directories available on the web, such as those available at Yahoo! Using the database of directory keywords, the closest match between the text comprising the URL and the directory keyword text may be found, and subsequently the category information associated with the best match directory hierarchy branch may be used to populate the datagram for the particular page. A directory database is typically comprised of 1) a category tree 2) a list of urls and possible descriptions, titles, etc. as leaves of the tree. Example of a branch is Top/Shopping/Clothing, example of a leaf is (www.gap.com/“Clothing Store”). We lookup www.gap.com (or a subportion of a url), and return Shopping:Clothing. If the URL is listed in more than one branch, the invention returns the best match directory hierarchy branch, as is stated above.

Automated Rulebuilding using Seed Data:

In another variation, a specific rule may be created automatically using a database of known “seed data”. This procedure works similarly for correcting existing specific rules which fail to properly execute for some reason, such as a formatting change at a previously known page such as the product pages at Amazon.com.

In this variation, a local or remote database contains “seed” content from various web pages matched to keywords such as “author”, “title”, or “ISBN”. This database is used as a source of “seed data” for building new rules. An example is helpful for describing this variation. Assume the User is at JoesBooks.com, a little known web site for books. When the User goes to a product page at JoesBooks.com, the rule trigger logic (described above) finds no direct matches based upon the URL information and is unable to execute a specific rule because none exist in the rule database, which may be local or remote on a server, for JoesBooks.com product pages. The database contains datagram information for seed books, such as “John Grisham, The Firm” and “Michael Crichton, Sphere” comprising their respective titles, authors, and ISBN numbers. The rule creation logic must next determine how to get to the product pages for seed books. This generally comprises finding a “submit” box on a page, navigating a product tree within the web site, or, as is preferable, inserting the product name or portions thereof into a query string, generally by adding such text to the URL as is known in the art of internet querying. At this point, the rule creation logic should have adequate means to get to the “John Grisham, The Firm” book product page, for example—and this is precisely what happens: the specific product page for “John Grisham, The Firm” is found at JoesBooks.com.

Next the content of the product page is downloaded, locally or to a remote server for processing. For the purposes of this example, this process is repeated for other known books, such as “Michael Crichton, Sphere”. The process is repeated more times if the product pages at JoesBooks.com are less highly correlated than many other typical product pages are (see, for example, the product pages of Amazon.com; they are highly correlated in format). In one variation, the process is repeated the same number of times for any site—a number which affords a high degree of certainty that any variance within a sites product pages has been covered. With a relatively homogeneous site, in terms of product or item page formatting, 25 or so cycles is probably enough information to create a successful specific rule. Techniques for directly assessing the correlation of pages of a web site are known in the art of datamining and internet programming. A key aspect of this format correlation: the downloaded pages have a high correlation of quite a few things, and some key things which always differ upon comparison.

The content downloaded from each page is then analyzed. First, there must be a determination of what keywords or tags will be required of the rule. In this book example, assume that it is necessary that the rule be able to extract “Author”, “Title”, and “ISBN”. Starting with “author”, the rule creation logic will search the downloaded content of the “John Grisham, The Firm” page and will create a separate minimum regular expression, preferably, to extract each occurrence of “John Grisham”. If “John Grisham” occurs three times on the JoesBooks.com page for that product, the three minimum regular expressions to may, for example look like:

#1: I books by <a href=“[ˆ ”]”>([,a-zA-Z0-9 ′&:\.\])\[\(\)#\-]*[a-zA-Z0-9\(\)\]\[ ])[ ]*{cube root}\a>≧”

#2:<img width=60 height=92 src=“[ˆ ”]*” alt=“([,a-zA-Z0-9 ′&:\.\]\[\(\)#-]*[a-zA-Z1-9\(\)\]\[ ]]*Store” border=“0”>

#3:>”by <a href=“ˆ ”]*”>([,a-zA-Z0-9 ′&\.\]\[\(\)#\-]*[a-zA-Z0-9\(\)\]\[ ])[ ]*<\a>”

Continuing with the subprocess for developing a rule or subpart thereof for properly extracting the “author” from a JoesBooks.com product page, the rule creation logic will analyze the content of the “Michael Crichton, Sphere” page and create minimum regular expressions for each occurrence of “Micheal Crichton” on the page, resulting, for example, in three occurrences and three minimum regular expressions:

#1: I search books for<a href=“[ˆ ”]*”>([,a-zA-Z0-9 ′&:\.\]\[\(\)#\-]*[a-zA-Z0-9\(\)\[\(\)#\-]<\a><”

#2:>“by <a href=“[ˆ ”]*”>([,a-zA-Z0-9 ′&:\.\]\[(\)#\-]*[a-zA-Z0-9\(\)\(\)\]\[ ])[

#3>([,a-zA-Z0-9 ′&:\.\]\(\)#\-]*[a-zA-Z0-9\(\)\[ ])[ ]*Store<

Note that in these expressions, the original text “John Grisham” and “Michael Crichton” has been replaced as appropriate with a regular expression to match any author for the sample set (e.g., ([,a-zA-Z0-9 ′&:\.\]\[\((\)#\-]*[a-zA-Z0-9\(\\][ ])). From this analysis of two pages, one can see that the third expression for the Grisham book is identical to the second expression for the Crichton book. This expression may be chosen as the candidate for extracting “author” from a JoesBooks.com product page. If this identity was not found, the next best choice for a minimal expression would be the merger of the first expression from each (e.g., I(books by|search books for)<a href=“[ˆ ”]*“>([,a-zA-Z0-9 ′&:\.\]\[\(\)#\-]*[a-zA-Z0-9\(\)]\[ ]) [ ]*</a><”).

This expression is then applied across the sample set to see if it still works/returns correct results. If not, the next best set is chosen. Assuming the identical expression #3 from “John Grisham” and #2 from the “Michael Crichton” is reapplied across the entire sample set (only two are shown here) and succeeds, it is chosen.

This process is repeated for each basic datum one wants to extract from a page (e.g. redo for Titles, in this case “The Firm” and “Sphere” respectively, then for ISBN number, etc. ). Note that additional heuristics may be applied to help the minimal expression generation by added rules about relations between each item/datum on a page the user is extracting (e.g. choose expressions where the datums found are close to each other, if more than one is found they must repeat, e.g. author,title, author,title, etc. ).

Once all the expressions have been found, they are packaged together into a rule, and the rule associated with the common portion of the URL (e.g. www.JoesBooks.com/products/ . . .) with which the dataset is associated.

The rule may be generated in various format, such as java, jscript, or compact data form. An example of compact data form is as follows:

<rule>

<extractionset language=“regex”>

<extractionItem>

<regex>>“by <a href=”[ˆ “]*”>([,a-zA-Z0-9 ‘&:\.\]\[\(\)#\-]*[a-zA-Z0-9\(\)\]\[])[

]*</a>“</regex>

<tag id=“0”>author</tag>

</extractionItem>
<extractionItem>

<regex>>“ <font size=0×3><b>([,a-zA-Z0-9 ‘&:\.\]\[\(\)#\-]*[a-zA-Z0-9\(\)\]\[])[

]*</b></font>“</regex>

<tag id=“0”>title</tag>

</extractionItem>

...

</rule>

Regardless of the form of the rule, its output as a datagram is typically the same: an XML packet where each datum's tag (in this case, author and title) is the tag of an XML element:

<datagram>

<author>John Grisham</author>
<title>The Firm</title>

</datagram>

Such an XML object is easily parsed and stored into the database as a grouping of tag/value pairs.

Generating and executing rules for sets of relatively homogeneous single item pages, such as the book product pages viewable at Amazon.com, is made relatively routine using these automatic rule generation techniques. Tables or lists of items on a single page, otherwise known as a “multiple product page” presents a more complex problem. To illustrate, imagine a web vendor called AllMedia.com which sells books, movies, DVDs, etc. If a user browses to a single product page for “John Grisham, The Firm” at AllMedia.com, the distilled content techniques should be able to extract a datagram from the content available at the page. But the scenario wherein the same query to AllMedia.com returns a table having three different listings for “John Grisham, The Firm”, one for the book format, one for the videotape, and one for the DVD, is different. A table has regularity just like a group of correlated product pages; the key difference is that single product pages are associated with one item, while multiple product pages are associated with more than one item, and it is unclear upon first glance how many items. If there is more than one item, additional information can be added to the datagram or database regarding “John Grisham, The Firm”—namely that it is available in other formats.

To test the relationship of the other items to the one which caused a rule to properly execute, a “trusted source” is used for benchmarking. The text information associated with each of the other items is sent in a query format to a trusted source, such as Amazon.com. If the other items (namely the DVD and videotape) are found at the trusted source to be associated with “John Grisham, The Firm”, then the additional information, namely a “new tag/value pair” associated with the others in the grouping for “John Grisham, The Firm”, may be added to the grouping on the database for future reference.

Use of Datagrams:

In the preferred variation, transfer of information between the user's browser software and the plug-in, as well as the production of datagrams using rule trigger logic and executed rules, is conducted in the background so the user may continue to browse the web. After a datagram is constructed, it is preferably sent to a datagram processing system, such as a server, using the Internet conduit with which the user is browsing the web. Sending the datagram information from the plug-in an outside system is accomplished using standard protocols known to Internet programmers, such as HTTP (hypertext transfer protocol). The datagram processing system may also reside on the user's local information system.

Having the distilled information from more than one location allows for high-speed processing and analysis: partially due to the distilled nature of the datagram information, and partially due to the advantage of having the tag/value pairs in one location with known formats. The ability to distill the content of web pages into datagrams may be leveraged as an enabling portion of one variation of the inventive system and method comprising reduced display browsing. The inventive techniques for distilling web page content may also be leveraged for datamining purposes.

Reduced Display Browsing:

Reduced display browsing enables users to browse the web using devices such as PDAs, cell phones, pagers, or even watches which have small display screens in comparison to more traditional computer monitors for which much of the browsing software was designed. Some local information systems and their related networks, such as digital cell phones and service available from Sprint PCS or the “Palm-7“PDA from Palm Computing and it's associated digital broadcast service, enable limited web browsing using a small, relatively low resolution liquid crystal display present on the telephone hardware. Since a typical web page contains more text than can be readably displayed on such a display, services such as Sprint PCS broadcast reduced versions of certain web pages for users to read and interact with.

For example, some cellular phone services allow users to check stock quotes or use certain search engine pages. They generally do not, however, allow users to freely browse the web because much of the distillation of content available on the pages supported by the service is done via direct data export from the particular pages which are supported. For example, a cellular service may have an agreement in place with a stock quote web page wherein the stock quote service transmits the distilled data desired by the cellular service to the cellular service for subsequent transmission to users on their cell phones or PDAs.

Datagram formation enables direct export of distilled content from a given web page after a rule is fired. The distillation may occur at the direction of the broadcasting service provider, or it may occur automatically as the user browses from his limited display information system.

Datamining:

Another usage of datagrams is for data mining applications (also known as “data warehousing”). In datamining applications, the user or operator generally is interested in capturing or “mining” certain key portions of content from a larger set available on a web page or other information repository. The formation of datagrams in accord with the present invention may be leveraged as a routine for “mining” key content from websites since they contain distilled versions of the web pages generally comprising the portions of these pages likely to be most relevant to a user interested in datamining. Datagrams contained structured data, preferably formatted in XML, which allows other applications such as datamining applications to easily capture and organize key information.

### EXAMPLES

### Example: Datagram Extraction

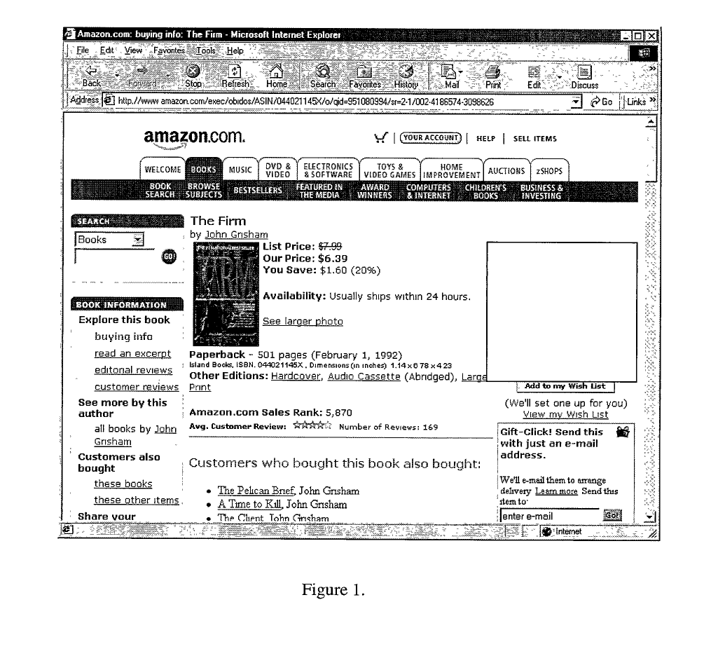

1) Web pages are found and accessed by what is referred to as a “URL” or “Uniform Resource Locator”. The URL http://www.amazon.com/exec/obidos/ASIN/044021145X refers to the following page shown in FIG. 1.

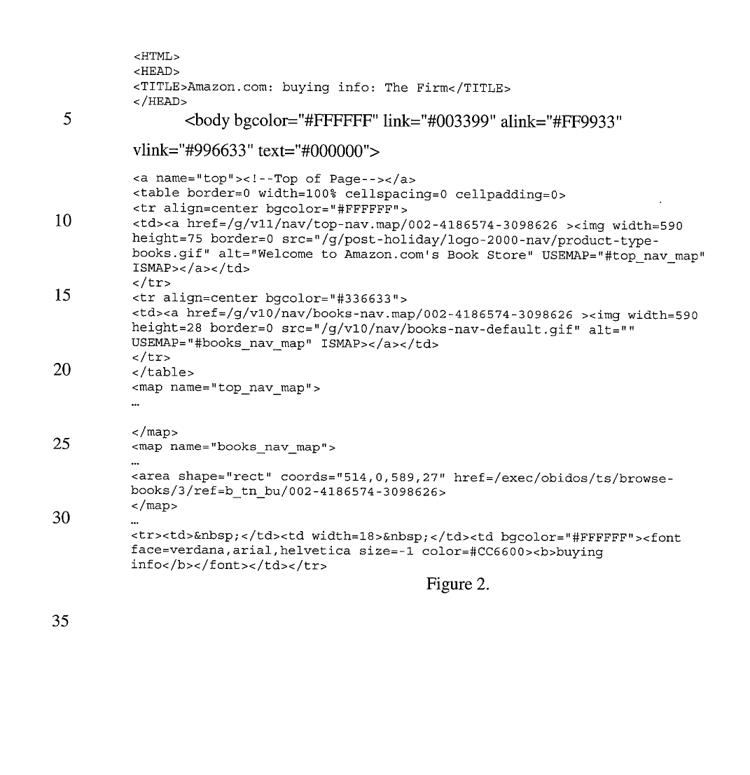

A sample of the actual text, or HTML, of this page is shown in FIG. 2.

This is only a small portion of the HTML text—the entire page as seen above contains far more text.

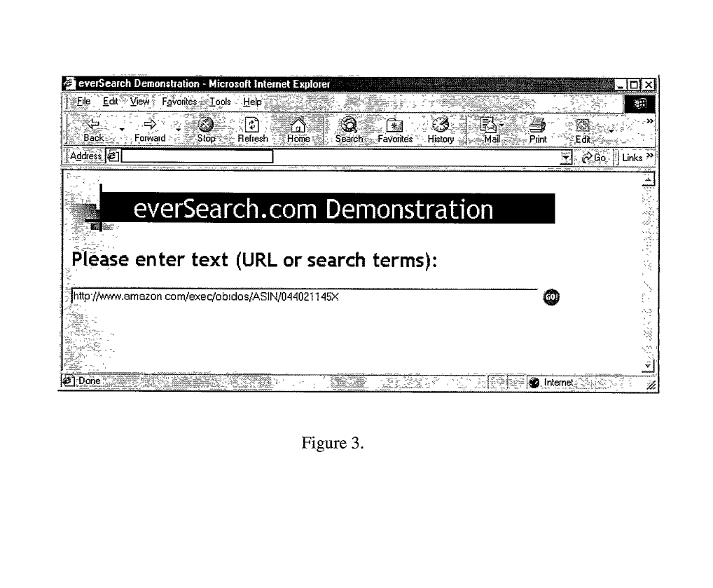

2) In one embodiment of the invention, the URL as seen above can be submitted to a remote processing server. A visual description of doing this via the web may look like that in FIG. 3.

The server processes the URL and uses trigger logic to find what rule to execute on the returned content associated with this URL. The content (generally in HTML format) represented by this URL is downloaded, and the rule executed.

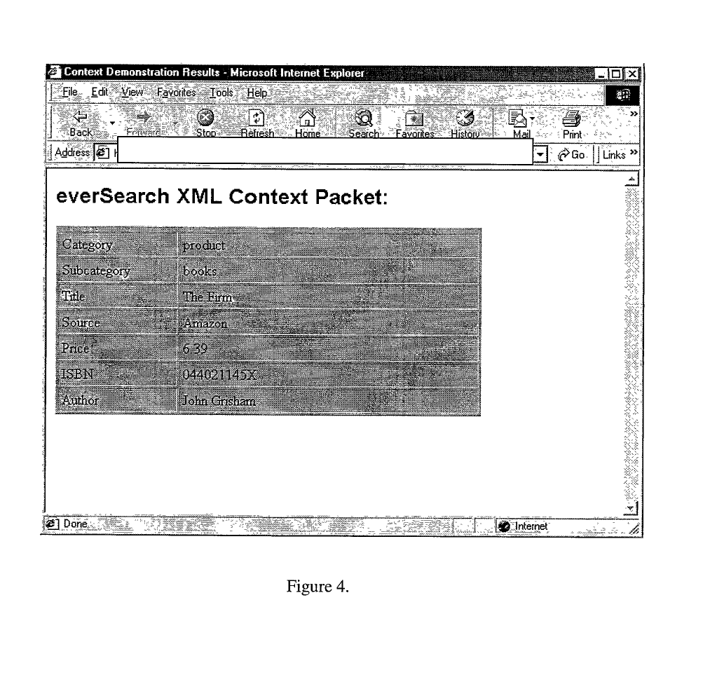

The server then responds with a datagram, preferably an XML packet, here visually laid out in HTML in FIG. 4 for clarity.

The actual XML for the returned packet would look similar to:

<node>

<Category>product</Category>
<Subcategory>books</Subcategory>
<Title>The Firm</Title>
<Source>Amazon</Source>
<Price>6.39</Price>
<ISBN>044021145X</ISBN>
<Author>John Grisham</Author>

</node>

Note two significant things which have occurred: 1) A huge amount of data, in this case a large amount of HTML data describing this particular page, has been reduced by a rule to the key pieces of distilled information; 2)

The distilled information has been packaged into a highly structured form, readable by both humans and machines. This technology is very useful for databasing, datamining applications, and reduced display devices such as cellular phones and PDAs, among other things.

### Example: Browser Plug-in (or “Browser Companion”) and Feedback to the User

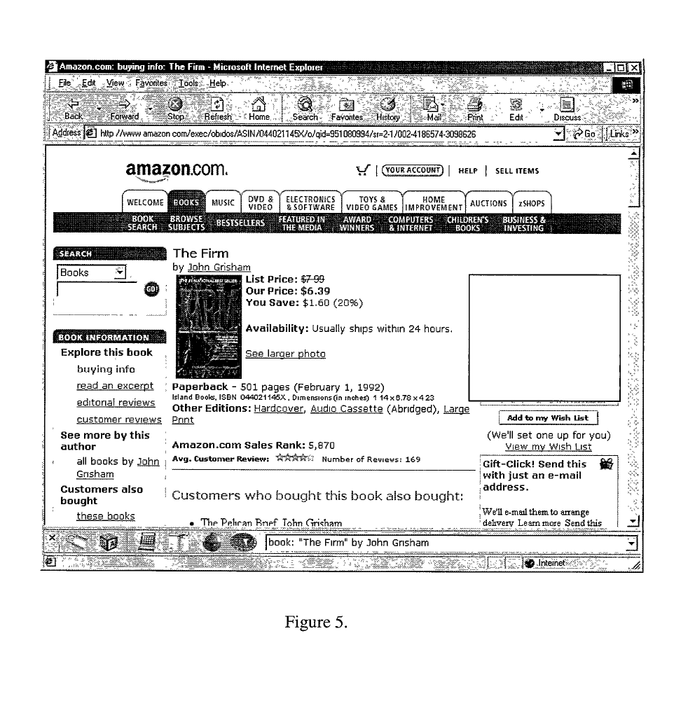

1) In this example, referring to FIG. 5, the user has installed a browser companion, powered by the inventive datagram creation technology, to work with the browser software. In this variation, the companion gives feedback to the User with a “toolbar” which can be seen at the bottom of the browser display.

2) Here, the User is looking at the book: “The Firm” by John Grisham at Amazon.com.

3) The browser companion displays for the User a feedback display regarding the particular page the User is looking at (“The Firm” by John Grisham). With the browser companion variation, the rules and rule triggers can be cached on the users machine (no immediate need to access the server if the rules are present ). (FIG. 5).

### Example: “Reverse Lookup” Default Rule Situation

1) In this example, the user has installed a browser companion, having datagram formation technology, to work with the browser software. This companion can be seen at the bottom of the browser, as a horizontal “toolbar.”

2) The user has gone to a new travel site, “Caribbean-connection.com”

3) Assuming no specific rule exists, the system may do a reverse lookup through a directory database (e.g. the “open directory”) to uncover the fundamental category for this site. This is novel in that such directory systems typically are used on site where the user enters a category, or traverses a category tree, to get to a site. Here, the user is already at a site, and the lookup is done to “reverse” the user to information regarding the appropriate category.

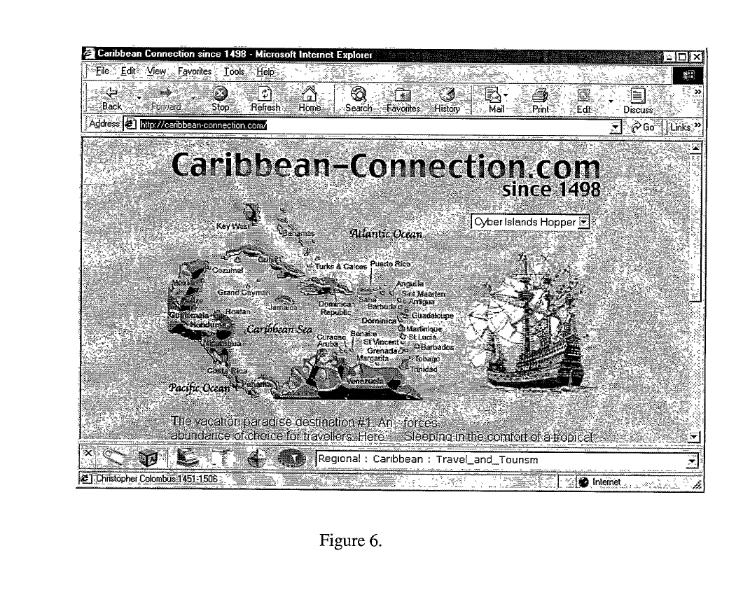

4) The resulting category in the plugin browser are shown in FIG. 6.

5) this category information may then be used to trigger appropriate related material.

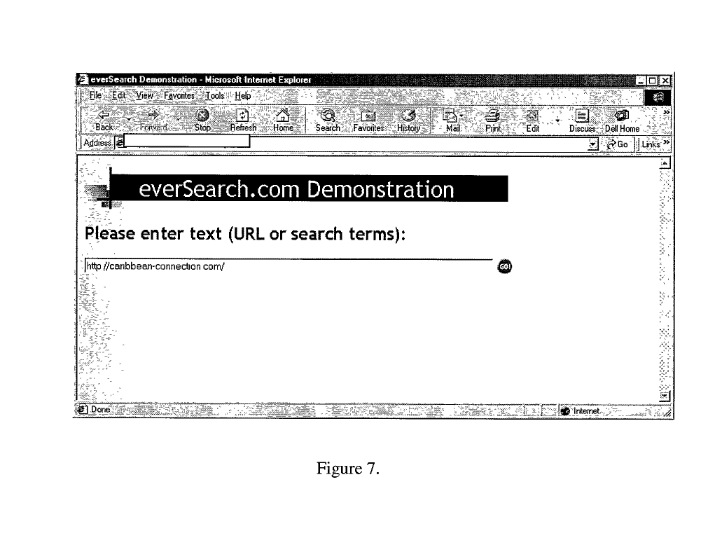

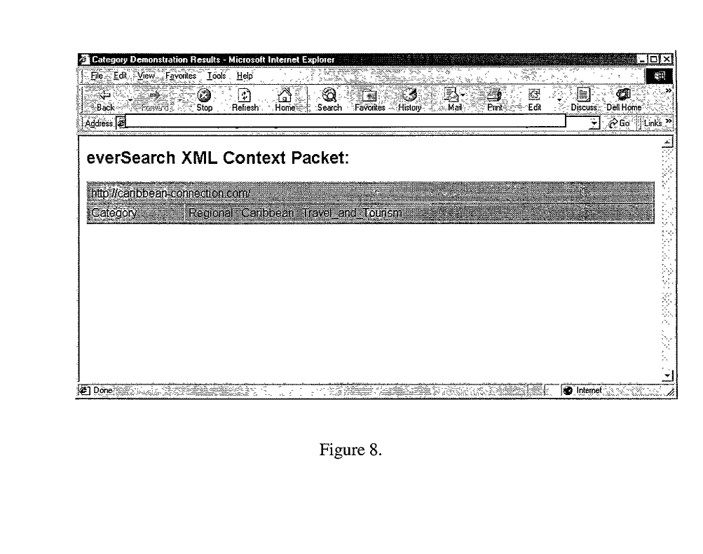

The process can been seen visually by direct access to the knowledge base as shown in FIGS. 7 and 8.

1) enter URL (FIG. 7).

2) The server responds with results (FIG. 8)

1. (form datagram using rules) A method for extracting content from Internet location information comprising:
a. comparing the URL information associated with an Internet location as well as subportions of said URL with a rule trigger in a manner which compares characters comprising said URL or subportions of said URL with rule trigger characters comprising said rule trigger to find at least one match;
b. executing a rule algorithm to extract subexpressions from the HTML and URL information associated with the Internet location and compile said subexpressions into a datagram.

2. (use HTML to for rule triggering) The method of claim 1 wherein the step of comparing further comprises comparing the HTML information associated with an Internet location with a rule trigger in a manner which compares characters comprising said HTML information with characters comprising said rule trigger to find at least one match.

3. The method of claim 1 wherein the rule is an XML object.

4. The method of claim 3 wherein the rule is a regular expression configured for extracting subexpressions from URL and HTML information.

5. The method of claim 1 wherein the step of comparing comprises using local plug-in software, which handshakes with local browser software operated on a local information system by said user, to import URL information associated with said Internet location from the local browser software and compare the URL and subportions thereof with the rule trigger.

6. The method of claim 1 wherein the step of comparing comprises using remote software running on a remote information system, which handshakes with local browser software operated on a local information system by said user, to import URL information from the local browser software and compare the URL and subportions thereof with the rule trigger.

7. The method of claim 5 wherein said rule is stored and executed on said local information system.

8. The method of claim 6 wherein said rule is stored and executed on said remote information system.

9. The method of claim 1 wherein the step of comparing between the URL or a subportion thereof and said rule trigger comprises using string compare logic to look for a match between the characters of the URL or subportion thereof and said rule trigger characters.

10. (when executing rule remotely, send URL from local, but download HTML directly at remote) The method of claim 8 wherein said URL information is sent to said remote information system from said local information system, while said HTML information is downloaded directly to said remote information system from said Internet location using said URL information.

11. (reduced display browsing) The method of claim 1 further comprising the steps of:
a. transmitting said datagram to a wireless information system; and
b. extracting said datagram to produce a reduced display view of the Internet location.

12. (default rule-1) A method for creating a rule algorithm for extracting selected content information from Internet location URL and HTML information comprising:
a. comparing the URL information associated with an Internet location as well as subportions of said URL with each of a set of rule triggers in a manner which compares characters comprising said URL or subportions of said URL with rule trigger characters of each rule trigger and calculates a score for each comparison based upon the number and weight of matches for a given comparison;
b. determining which rule trigger is the highest scoring rule trigger and determining that said highest score is greater than or equal to an application threshold score; b. executing a rule algorithm associated with the highest scoring rule trigger to extract subexpressions from the HTML and URL information associated with the Internet location and compile said subexpressions into a datagram.

13. (use HTML to for rule triggering) The method of claim 11 wherein the step of comparing further comprises comparing the HTML information associated with an Internet location with a rule trigger in a manner which compares characters comprising said HTML information with characters comprising said rule trigger to find at least one match.

14. The method of claim 11 wherein the rule is an XML object.

15. The method of claim 13 wherein the rule is a regular expression configured for extracting subexpressions from URL and HTML information.

16. The method of claim 11 wherein the step of comparing comprises using local plug-in software, which handshakes with local browser software operated on a local information system by said user, to import URL information associated with said Internet location from the local browser software and compare the URL and subportions thereof with the rule trigger.

17. The method of claim 11 wherein the step of comparing comprises using remote software running on a remote information system, which handshakes with local browser software operated on a local information system by said user, to import URL information from the local browser software and compare the URL and subportions thereof with the rule trigger.

18. The method of claim 15 wherein said rule is stored and executed on said local information system.

19. The method of claim 16 wherein said rule is stored and executed on said remote information system.

20. The method of claim 11 wherein the step of comparing between the URL or a subportion thereof and said rule trigger comprises using string compare logic to look for a match between the characters of the URL or subportion thereof and said rule trigger characters.

21. (when executing rule remotely, send URL from local, but download HTML directly at remote) The method of claim 18 wherein said URL information is sent to said remote information system from said local information system, while said HTML information is downloaded directly to said remote information system from said Internet location using said URL information.

22. (default rule-2) A method for creating a rule algorithm for extracting selected content information from Internet location URL and HTML information comprising:
a. comparing the URL information associated with an Internet location as well as subportions of said URL with each of a set of rule triggers in a manner which compares characters comprising said URL or subportions of said URL with rule trigger characters of each rule trigger and calculates a score for each comparison based upon the number and weight of matches for a given comparison;
b. determining which matches have a score which is greater than or equal to an application threshold score;
c. compiling the matches into a datagram.

23. [creating rules using seed data] A method for creating a selected content extraction rule for a series of correlated content pages comprising:
a. downloading a first content-known page having first content comprising a first value for a keyword;
b. forming a first minimum regular expression for extracting said first value for said keyword;
c. downloading a second content-known page having second content comprising a second value for said keyword;
d. forming a second minimum regular expression for extracting said second value for said keyword;
e. comparing said first minimum regular expression with said second minimum regular expression to make a determination regarding which of said first minimum regular expression or said second minimum regular expression better extracts values for said keyword.
